(19) United States
(12) Patent Application Publication
(10) Pub. No.: US 2009/0154981 A1
(43) Pub. Date: Jun. 18, 2009

(54) COMPUTER WRIST REST FOR NOTEBOOK COMPUTERS

(76) Inventor: Michael E. Zuckerman, Atlanta, GA (US)

Correspondence Address: MEREDITH & KEYHANI, PLLC, 330 MADISON AVE., 6TH FLOOR, NEW YORK, NY, 10017, US

(21) Appl. No.: 11/957,916

(22) Filed: Dec. 17, 2007

(51) Int. Cl. A47B 21/013; B43L 15/00

(52) U.S. Cl. 400/715; 248/118.1

(57) ABSTRACT

An apparatus for relieving and preventing repetitive stress on a portion of a user's hand while using the keyboard and/or a mousing device on a notebook computer, the apparatus comprising: an elongated pad portion smaller in width than the bottom portion of the notebook computer; and a mousing opening cutout from the elongated pad portion adapted to surround the mousing portion of the notebook computer.

The present invention relates to wrist rests for use with notebook or laptop style computers.

There are many different types of personal computers on the market, including desktop and laptop or notebook. As society becomes more mobile, notebook computers are a desirable computing solution. Lightweight notebook computers have the advantage of being lightweight and include peripherals (such as mousing devices, keyboard and screens) built into a single device. The placement of the integrated mouse pad is generally in a bottom portion below the keyboard in a laptop computer. While this is very convenient and compact, it may cause significant trauma to the hand, requiring mousing at an awkward angle.

As the number of computer users has increased the number of repetitive stress disorders has also increased. Carpal tunnel syndrome is a common problem among computer users and may be characterized by a tingling, numbness, loss of gripping. Another problem is irritations, from repetitive contact with hard computer parts.

In a notebook computer, to correct the issue, the user may plug in a second mouse and use a mouse pad. While this may address the problem, it is cumbersome and requires the computer user to have a second mouse and large mouse pad. Also, some users prefer the style and mousing mannerisms of the incorporated mouse. The present invention addresses these issues by providing a wrist rest for use with the integrated mousing device of a notebook computer.

These and other features, aspects and advantages of the present invention will become better understood with reference to the following description and claims.

### SUMMARY OF THE INVENTION

The present invention relates to wrist rests for use with notebook or laptop style computers.

According to one embodiment of the present invention, an apparatus for relieving and preventing repetitive stress on a portion of a user's hand while using the keyboard and/or a mousing device on a notebook computer, the apparatus comprising: an elongated pad portion smaller in width than the bottom portion of the notebook computer; and a mousing opening cutout from the elongated pad portion adapted to surround the mousing portion of the notebook computer.

According to another embodiment of the present invention, an apparatus for relieving and preventing repetitive stress on a portion of a user's hand while using the keyboard and/or a mousing device on a notebook computer is provided, the apparatus comprising: an elongated pad portion shaped for receipt along the bottom portion of said notebook computer; a mousing opening cutout from said elongated pad portion adapted to surround the mousing portion of said notebook computer, said mousing opening cutout having four sides and each of said four sides is tapered towards said mousing portion of said notebook computer;

These and other features, aspects and advantages of the present invention will become better understood with reference to the following description and claims.

### BRIEF DESCRIPTION OF THE DRAWINGS

FIG. 1 depicts the present invention;

FIG. 2 depicts the present invention;

FIG. 3 depicts the present invention;

FIG. 4 depicts the present invention;

FIG. 5 depicts the present invention;

FIG. 6 depicts the present invention;

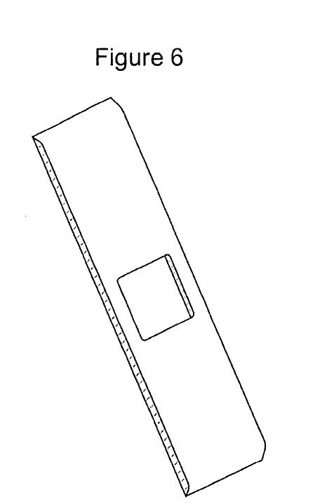

FIG. 7 depicts the present invention;

FIG. 8 depicts the present invention; and

FIG. 9 depicts the present invention.

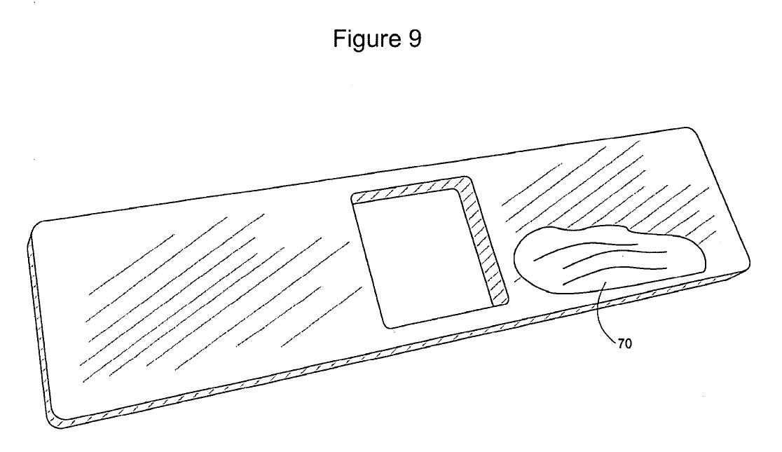

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

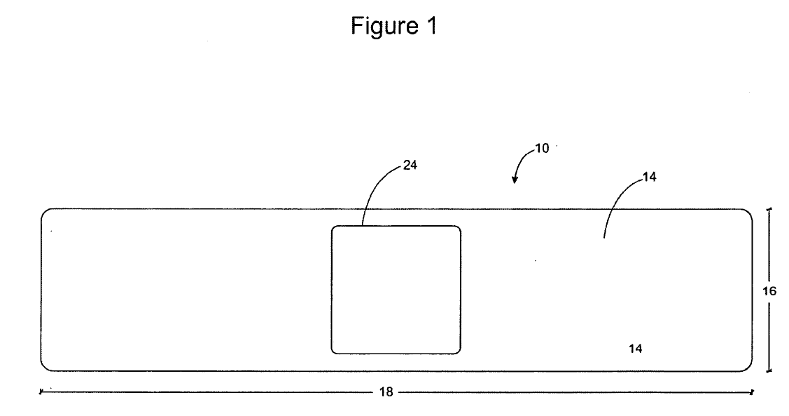

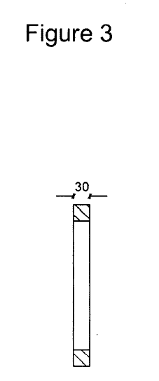

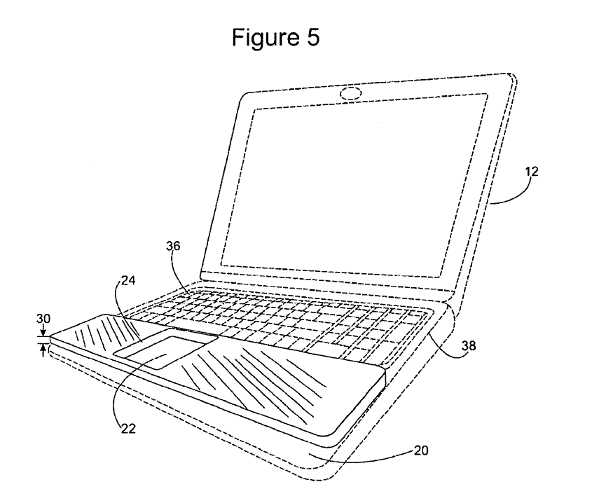

With reference to FIGS. 1-5, an apparatus (10) for relieving and preventing repetitive stress on a portion of a user's hand while using a the keyboard and/or mousing device on a notebook computer (12) is provided, the apparatus (10) comprising: an elongated pad portion (14) smaller in width (18) than the bottom (20) portion of a notebook computer (12). That is to say the elongated pad portion (14) has a width slightly smaller than the width of the bottom portion (20) of the notebook computer. The term bottom portion (20) of the notebook computer is intended to refer to the area below the keyboard, where the mousing device (22) is incorporated. This may be important to note in the event the bottom portion is of a different width than the keyboard portion (which generally it is not). The apparatus (10) has a mousing opening (24) cutout from the elongated pad portion (14) adapted to surround the mousing portion (22) of the notebook computer. The terms notebook computer, laptop computer and portable computer are interchangeable and would be appreciated by those of skill in the art to refer to computer with a keyboard, mouse and monitor in a single apparatus.

The elongated pad portion (14), according to a preferred embodiment is formed from solid polyurethane or solid polyurethane gel (PU GEL) and is at least the same height (30) as the profile of the keys of the keyboard when sitting on the bottom portion (20) of the notebook computer (12). The profile of the keys (36) is intended to refer to the height of the keys (36) above the notebook computer casing (38). It is desirable to have the users wrist wrest at a height above the keys. The apparatus may also be made from visco-elastic polyurethane foam or Memory foam. Memory foam is made from polyurethane with additional chemicals that add to its viscosity level, increasing its density. Because of this, it is often referred to as visco-elastic polyurethane foam. Depending on the chemicals used and its overall density, it is firmer in cool temperatures and softer when warm. Higher density memory foam reacts to body heat which allows it to mould itself to the shape of a warm body within a few minutes. A lower density memory foam is pressure-sensitive and will mould more quickly to the shape of the body. The example often used to demonstrate its properties is that a hand pressed into the foam and then removed will leave a clear impression of the hand in the foam. Textured solid polyurethane may be formed during molding or may be textured by the additional of a course material (e.g. sand) or even a texture creating spray. If formed during molding, indentations and raised portions would form the texture.

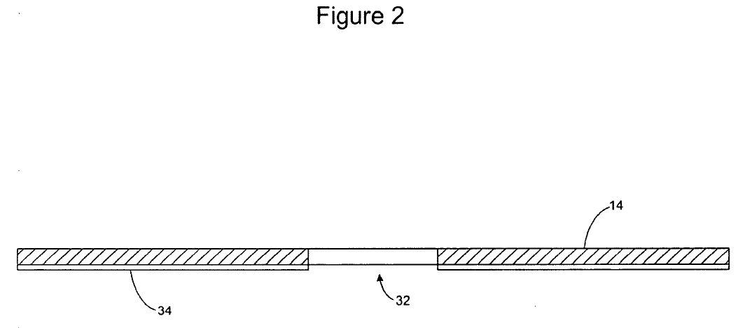

As depicted in FIG. 2, there may be a thermoplastic polyurethane film (34) in communication with the underside of the elongated pad portion (14) and having a same sized cutout (32) as the mousing opening cutout. That is to say the film (34) is the exact size as the underside of the elongated pad portion and serves to keep the apparatus (10) is place while mousing and typing. The film is unique as it adheres firmly to standard notebook/laptop style computer cases yet peels off without leaving any residue. There may also be an attachment means in communication with the underside of the elongated pad portion. The attachment means may be, for example, Velcro® hook and loop fasteners. Or a mechanical attachment means, such a clips.

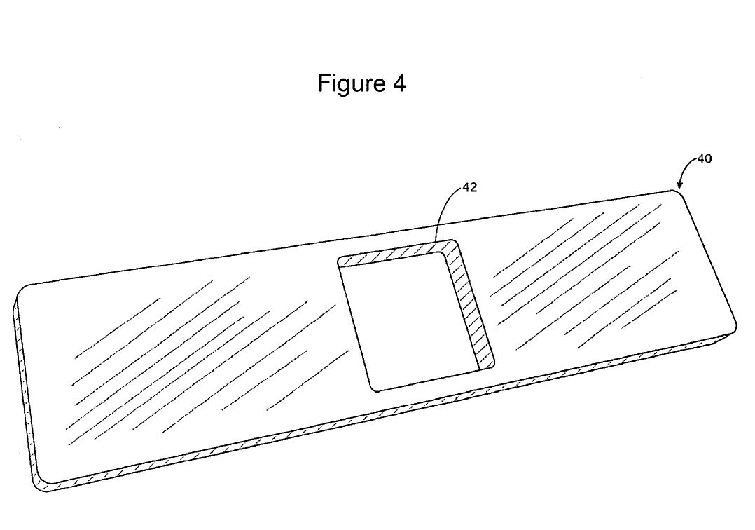

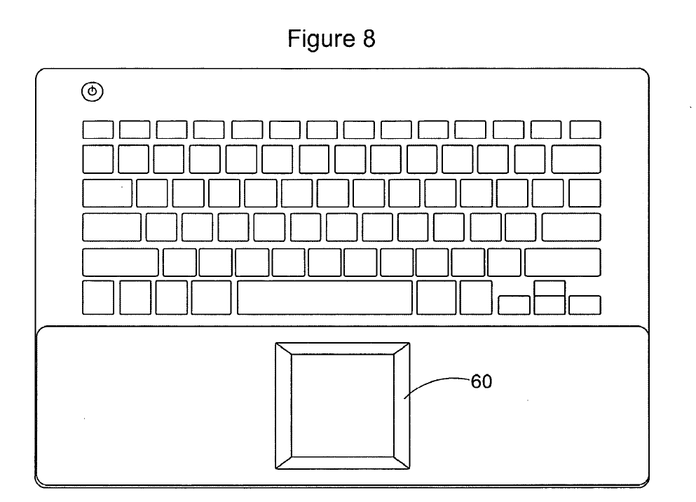

As shown in FIG. 4, the edges (40 and 42) may be rounded. According to another preferred embodiment, the mousing opening cutout (24) is substantially square having four sides and each side is tapered (60). The term tapered is intended to mean that the sides slope, as can be in FIG. 8. This is desirable for a number of reasons. It guides the fingers towards the mousing device and creates soft corners for mousing.

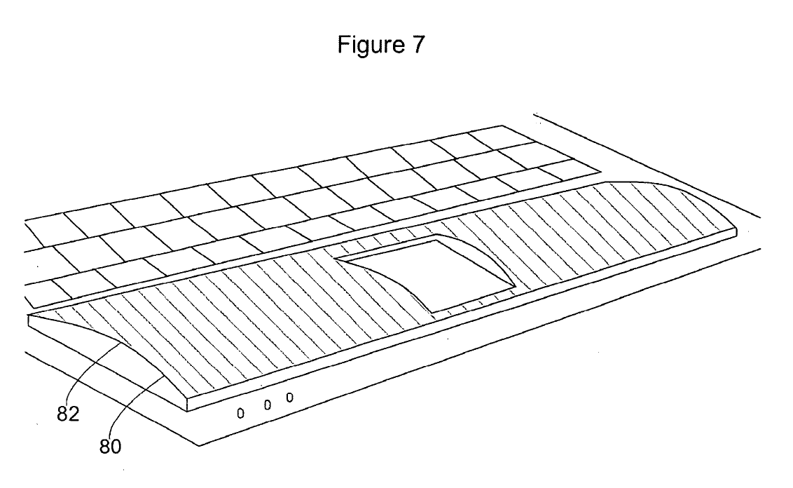

As shown in FIG. 7, the elongated pad portion is curved (80) being elevated towards the center (82) and the mousing opening cutout (24). This is desirable for elevating the hand during mousing and providing a rest for the forearm of the user while using the keyboard.

There may also be an elevated mound (70) on at least one top side of the elongated pad portion (24). This is for the receipt of the user's palm during mousing to keep the hand in a position less prone to repetitive stress.

It should be understood that the foregoing relates to preferred embodiments of the invention and that modifications may be made without departing from the spirit and scope of the invention as set forth in the following claims.

I claim:

1. An apparatus for relieving soreness and preventing repetitive stress on a portion of a user's hand while using a notebook computer, said apparatus comprising:
an elongated pad portion smaller in width than the bottom portion of said notebook computer; and
a mousing opening cutout from said elongated pad portion adapted to surround the mousing portion of said notebook computer.

2. An apparatus as in claim 1, wherein said elongated pad portion is at least the same height as the profile of the keys of said keyboard when sitting on said bottom portion of said notebook computer.

3. An apparatus as in claim 1, further comprising a thermoplastic polyurethane film in communication with the underside of said elongated pad portion and having a same sized cutout as said mousing opening cutout.

4. An apparatus as in claim 1, further comprising an attachment means in communication with the underside of said elongated pad portion.

5. An apparatus as in claim 1, wherein said apparatus is formed from solid polyurethane, PU GEL, visco-elastic polyurethane foam, nylon covered PU GEL or textured solid polyurethane.

6. An apparatus as in claim 1, wherein said mousing opening cutout is substantially square having four sides and each side is tapered.

7. An apparatus as in claim 1, wherein said elongated pad portion is curved being elevated towards the center and said mousing opening cutout.

8. An apparatus as in claim 1, wherein at least one side of said elongated pad portion tapers.

9. An apparatus as in claim 1, further comprising an elevated mound on at least one top side of said elongated pad portion.

10. An apparatus as in claim 9, wherein said elevated mound is oval shaped for receiving the user's palm.

11. An apparatus for relieving and preventing repetitive stress on a portion of a user's hand while using a notebook computer, said apparatus comprising:
an elongated pad portion shaped for receipt along the bottom portion of said notebook computer;
a mousing opening cutout from said elongated pad portion adapted to surround the mousing portion of said notebook computer, said mousing opening cutout having four sides and each of said four sides is tapered towards said mousing portion of said notebook computer;

12. An apparatus as in claim 11, wherein said elongated pad portion abuts the bottom of the keyboard of said notebook computer.

13. An apparatus as in claim 11, wherein said elongated pad portion is at least the same height as the profile of the keys of said keyboard when sitting on said bottom portion of said notebook computer.

14. An apparatus as in claim 11, further comprising a thermoplastic polyurethane film in communication with the underside of said elongated pad portion and having a same sized cutout as said mousing opening cutout.

15. An apparatus as in claim 11, further comprising an attachment means in communication with the underside of said elongated pad portion.

16. An apparatus as in claim 11, wherein said apparatus is formed from solid polyurethane, PU GEL, visco-elastic polyurethane foam, nylon covered PU GEL or textured solid polyurethane.

17. An apparatus as in claim 11, wherein said elongated pad portion's side is curved being elevated towards the center and said mousing opening cutout.

18. An apparatus as in claim 11, wherein at least one side of said elongated pad portion tapers.

19. An apparatus as in claim 11, further comprising an elevated mound on at least one top side of said elongated pad portion.
